(19) United States
(12) Patent Application Publication
(10) Pub. No.: US 2009/0039995 A1
(43) Pub. Date: Feb. 12, 2009

(54) Permanent Magnet or Permanent Magnet Array having Uniform Flux Density

(76) Inventors: Ronald Kipp, Willow Street, PA (US); Steven W. Day, Rochester, NY (US); Don B. Olsen, Salt Lake City, UT (US)

Correspondence Address: THORPE NORTH & WESTERN, LLP., P.O. Box 1219, SANDY, UT, 84091-1219, US

(21) Appl. No.: 12/169,435

(22) Filed: Jul. 8, 2008

Related U.S. Application Data
(60) Provisional application No. 60/959,162, filed on Jul. 9, 2007.

(51) Int. Cl. H01F 7/02; H02K 21/16

(52) U.S. Cl. 335/304; 310/156.48

(57) ABSTRACT

A permanent magnet device includes a polarized permanent annular magnet having two oppositely charged poles faces. A magnetically conductive faceplate is disposed on each of the opposite pole faces of the permanent magnet. Each faceplate is sized, shaped and oriented to equally distribute the flux lines emanating from the permanent magnet, and to increase or concentrate the density of the magnetic flux field of a permanent magnet or permanent magnet device.

### PRIORITY CLAIM

Benefit is claimed of U.S. Provisional Patent Application No. 60/959,162, filed Jul. 9, 2007, which is herein incorporated by reference in its entirety for all purposes.

### GOVERNMENT RIGHTS

This invention was made with government support under Grant No. NIH HL64378 and Grant No. NIH HL077085 awarded by the National Institute of Health. The U.S. Government has certain rights in the invention.

### BACKGROUND OF THE INVENTION

1. Field of the Invention

The present invention generally relates to a permanent magnet apparatus, such as radial and axial permanent magnetic bearings, brush less motors, and to magnetic position sensing that requires a uniform distribution of magnetic flux.

2. Related Art

Precision ceramic permanent magnets are manufactured in a multitude of forms throughout the world to fulfill the needs of various applications, such as permanent magnetic bearings, brushless motors, electromagnetic actuators, speakers, microphones, and a variety of sensing applications such as limit switches and linear position sensors. The precision ceramic magnets that are used in these applications are manufactured to very high standards, but rarely, if ever, do they reach completely uniform field densities.

Uniform field densities are important in such precision applications for several reasons. For example, uniform field flux density within radial or axial permanent magnet bearings are required to accurately center (radial or axially) the rotating portion of the radial or axial permanent magnetic bearing within its stator housing. In another example, mechanical balancing of the rotating member in a high speed motor is a critical function that is routinely accomplished within the industry, but magnetic field balancing between the rotor (armature) segments is not. Additionally, Hall Effect sensors are well known electronic devices which can be used to accurately determine the position of a magnetic device based on the field flux density of the magnets. In each of the above applications the magnetic strength and the flux field uniformity, or lack there of, can play a dominate role in the success, failure, and operational consistency of these precision devices.

Unfortunately, cost, efficiency and technology limitations in manufacturing permanent magnets result in magnetic flux field density inconsistencies. Some of the technology related reasons for these magnetic flux inconsistencies can be broken down into several categories such as non-homogenous chemical composition of the ceramic permanent magnets; physical variations within manufacturing tolerances (concentricity, parallelism, etc.) for the magnets; variations in the electromagnetic field that activates the permanent magnet material; and residual variation in the orientation of the magnetic domains during magnetization. For these, and other related reasons, flux density variations in excess of 15% within individual precision magnets are common.

The strength of a permanent magnet, which is measured by its magnetic flux density, is comprised of the chemical composition of the ceramic, the volume of the ceramic material, the geometric form, and the applied strength of the magnetic field that activates the magnet. Perfectly uniform magnetic flux field density, although strived for, is rarely achieved in all of the above categories. Thus, even in the best of manufacturing processes a 2.5% field strength variation is a very high quality norm, and a 1% field strength variation may be achievable but at a very high premium. It will be appreciated, that the combination of the chemical non-homogeneity, physical dimension variations, and magnetic activation non-uniformity all operate in conjunction with each to form the magnets' properties, and variations within these parameters can produce either an additive or subtractive effect to the resulting flux field homogeneity.

Depicted in FIGS. 1a-1c is an axially polarized ring magnet 100 and section view 101 that is expanded in FIG. 2 to show the idealized flux lines 102 emanating from the axial surfaces 104. Also depicted in FIG. 2 is a linear Hall Effect sensor 103 that can be used to measure the magnetic flux density at various angular rotations, and at fixed Z step positions (+/−Z) as shown in FIG. 2. An ideal magnet, as shown in FIGS. 1a-2, would have equal flux densities at constant Z locations for all rotational points about the centerline of the magnet, and, thus, the results of a normalized plot of the radial flux density for an ideal magnet would be unity at any fixed Z position.

Accordingly, depicted in FIG. 3 is a normalized plot of the ideal magnet at a various angular rotations about the magnet centerline, and a fixed axial distance from the magnet face (Z) in which the physical parameters, such as a non-homogenous chemical composition, geometric dimensional variations, and/or a non-uniform magnet field activation process has resulted in a calculated field variation of +/−1.25%.

FIG. 4 depicts a normalized plot of empirical data of one of the many high precision magnet rings, similar in form to FIG. 1 that has been empirically characterized using a setup similar in concept to FIG. 2. The similarity in the calculated magnet flux density due to physical and/or chemical imbalance shown in FIG. 3, and the empirically measured values shown in FIG. 4 is more than coincidental, and illustrates that even slight variations within the chemical uniformity, magnet activation process, and/or dimensional variations of these ceramic magnets can lead to the undesirable magnetic effect of non-uniform flux field density.

It will be appreciated by those familiar with permanent magnet bearing suspension systems, magnetic position devices, and permanent magnet motors that one of the critical parameters within these components and systems is the uniform distribution of the magnetic flux. It will be further appreciated that magnetic offsets from the true centerline of these components can introduce unbalance within the system, place the support system at risk, and burden the control system with unnecessary and unwanted correction factors. As an example of the impact of this magnet unbalance, consider a permanent magnet bearing system where the operational clearances between the components are +/−0.010″, which are typical of the design constraints placed on magnetic bearing systems. If a magnetic flux field imbalance within any one of the system components introduces a physical magnetic offset of greater than 0.010″, then the levitation mechanism will be inoperative and the entire magnetic support mechanism will be in jeopardy. Additionally, the magnetic unbalance of all of the interacting components (rotor and stator) within the system can have a combined negative effect on the overall system performance.

For example, FIGS. 5a-5c are a schematic representation of an axially polarized permanent magnet bearing in which 151 and 152 are respectively the rotor and stator of this bearing. FIG. 6 is a theoretical plot of the flux density of the stator 152 in which a 2.5% flux density offset variation from the physical centerline has been introduced at the 90-degree vector. FIG. 7 is a theoretical plot of the flux density of the rotor 151 in which also a 2.5% flux density variation has been introduced, but in this instance the offset vector is located at 0 degrees. It will be appreciated that a 2.5% flux density variation within precision permanent magnets is well within the norm for these devices, and that with an ideal magnet, without flux density variations, these vector plots would reside directly on the unity circle. Specifically, with an ideal magnet, if the physical and magnetic centerlines shown in FIGS. 6 and 7 were coincident, then the combined force plot shown in FIG. 8 would trace the unity circle

FIG. 8 is a depiction of sum of the force vectors from FIGS. 6 and 7 that depicts the position the rotor to be offset from the centerline of the stator, and as the rotor is rotated it will whirl around following the combined force tracing shown in FIG. 8. It will also be appreciated that a myriad of other angle vectors and percentage of magnetic flux offsets can and do produce a multitude of other composite force shapes, and that the results shown within FIGS. 6, 7 and 8 are just examples that are presented to pictorially clarify the subject problems with these magnetic bearing arrangements. It should also be appreciated that numerous empirical tests of the individual rotor and stator magnets, and the composite magnetic bearing force generated by these components mimic the results depicted in FIGS. 6, 7 and 8.

### SUMMARY OF THE INVENTION

It has been recognized that it would be advantageous to develop a device for uniformly distributing the magnetic flux field emanating from a magnet. It has also been recognized that it would be advantageous to develop a device for concentrating, or increasing the density of magnetic flux field emanating from a magnet.

The invention provides a permanent magnet device including an axially polarized permanent annular magnet having two opposite faces. Additionally, a magnetically conductive annular faceplate is disposed on each of the opposite faces of the permanent magnet. Each faceplate is sized, shaped and oriented to equally distribute the flux lines emanating from the permanent magnet, and to increase the density of the magnetic flux field of the permanent magnet.

In another aspect, the invention provides for a permanent magnet bearing device. The bearing device can include an annular stator magnet having an axially polarized permanent annular magnet having a pair of opposite axial faces. The bearing device can also include a rotor magnet disposed within the stator magnet. The rotor magnet can have an axially polarized annular permanent magnet having a pair of opposite axial faces. Additionally, each of a plurality of magnetically conductive annular faceplates can be disposed on a respective axial face of the rotor and stator magnets. Each faceplate can be sized and shaped to uniformly distribute and concentrate, or otherwise manipulate a magnetic flux field emanating from the rotor and stator magnets. For example, in a radial permanent bearing the shape of these devices resembles a washer.

In yet another aspect, the invention provides for an electromagnetic motor device. The motor device can include a motor stator having an annulus shape and a plurality of magnetic poles disposed around the annulus. The motor device can also include a motor rotor disposed within the annulus of the motor stator. The motor rotor can include an axially polarized permanent magnet having a pair of opposite axial faces, and a plurality of magnetically conductive faceplates with each faceplate disposed on a respective axial face of the permanent magnet. Each faceplate can be sized and shaped to uniformly distribute and concentrate a magnetic flux field emanating from the rotor and stator magnets.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1a is a perspective view of an axially polarized ring magnet;

FIG. 1b is a front view of the axially polarized ring magnet of FIG. 1a;

FIG. 1c is a cross section view of the axially polarized ring magnet of FIG. 1a;

FIG. 2 is schematic view of the ring magnet of FIG. 1a, shown with idealized flux lines emanating from axial surfaces of the ring magnet;

FIG. 3 is a normalized plot of the flux density of a representative magnet at various angular rotations about the physical magnet centerline at one axial location inboard of Z+ or Z− and one radial location in which the representative magnet's physical and apparent magnetic centerlines have been offset;

FIG. 4 is a normalized plot of empirical flux density data of one of many high precision magnet rings similar in form to FIG. 1, in which the magnet's physical and apparent magnetic centerlines are offset due to various manufacturing issues such as chemical non-homogeneity, machining tolerances, residual radial polarization, and/or permanent magnet activation issues;

FIG. 5a is a perspective view of an axially polarized permanent magnet bearing;

FIG. 5b is a front view of the axially polarized permanent magnet bearing of FIG. 5a;

FIG. 5c is a cross section view of the axially polarized permanent magnet bearing of FIG. 5a;

FIG. 6 is a theoretical plot of the flux density of a stator of the magnetic bearing shown in FIG. 5a in which the stator's physical and magnetic centerlines are offset;

FIG. 7 is a theoretical plot of the flux density of the rotor of the magnetic bearing shown in FIG. 5 in which the rotor's physical and magnetic centerlines are offset;

FIG. 8 is the predicted magnetic bearing force caused by the interaction of the fields of the stator and rotor depicted in FIGS. 6 and 7

FIG. 9a is a perspective view of an axially polarized magnetic device in accordance with an embodiment of the present invention;

FIG. 9b is a front view of the axially polarized magnetic device of FIG. 9a;

FIG. 9c is a cross section view of the axially polarized magnetic device of FIG. 9a;

FIG. 10a is a perspective view of an axially polarized magnetic bearing device in accordance with another embodiment of the present invention;

FIG. 10b is a front view of the axially polarized magnetic bearing of FIG. 10a;

FIG. 10c is a cross section view of the axially polarized magnetic bearing of FIG. 10a;

FIG. 11a is a perspective view of an electromagnetic motor in accordance with another embodiment of the present invention;

FIG. 11b is a front view of the axially polarized magnetic bearing of FIG. 11a;

FIG. 11c is a cross section view of the axially polarized magnetic bearing of FIG. 11a;

FIG. 12a is a perspective view of a rotor of the electromagnetic motor of FIG. 11a;

FIG. 12b is a front view of the rotor of FIG. 12a; and

FIG. 12c is a cross section view of the rotor of FIG. 12a.

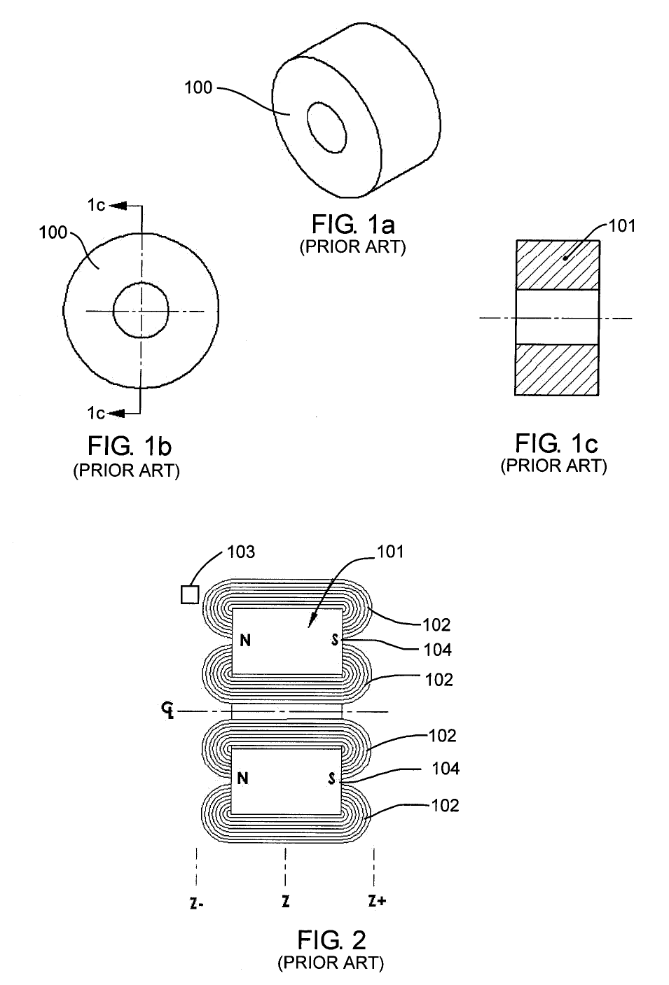

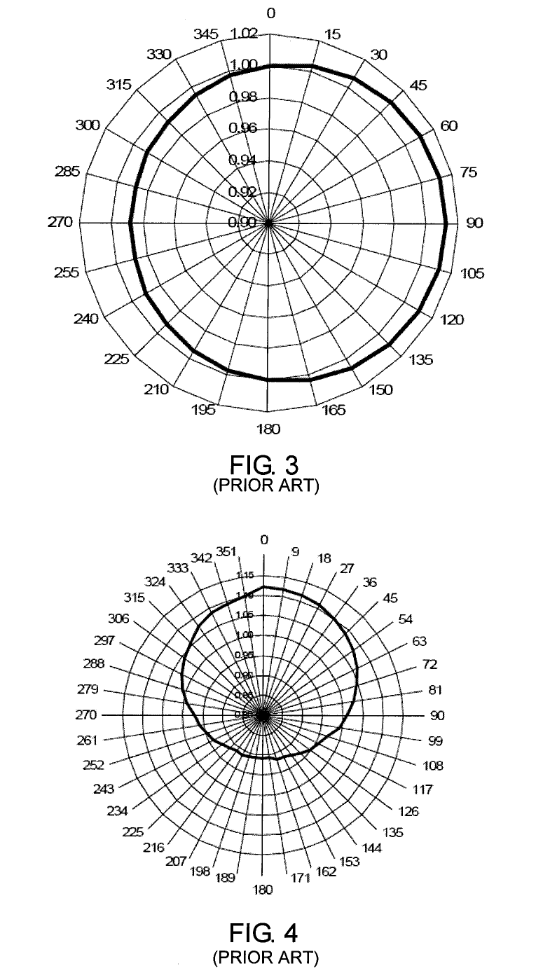

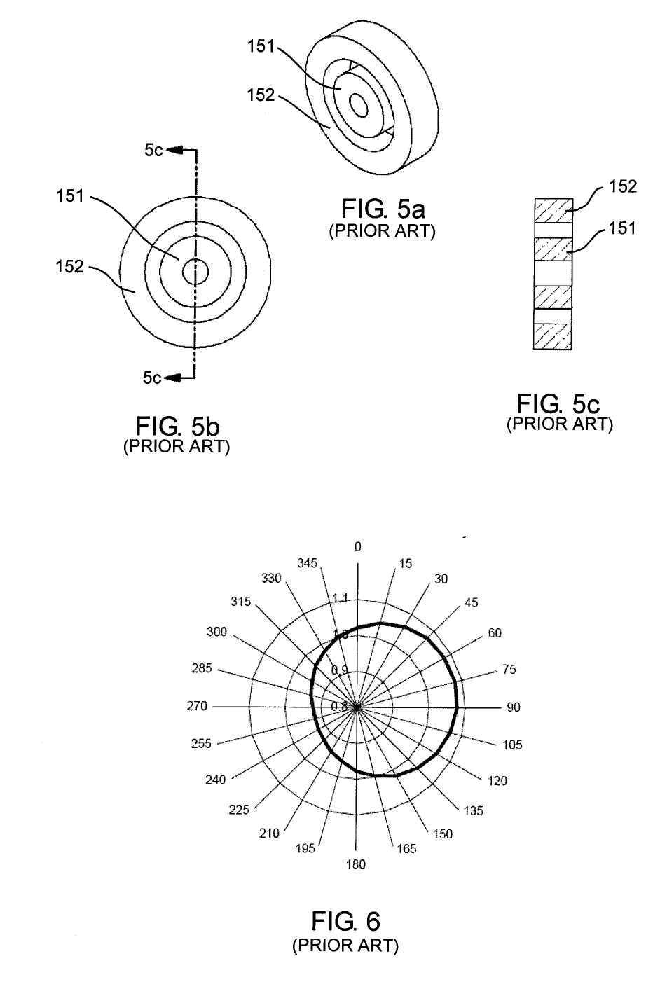

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein generally provide for a magnetic device that evenly distributes and concentrates the magnetic flux emanating from a magnet. It will be appreciated that magnetic flux or flux lines propagating through a soft magnetic medium, such as iron or steel volumetrically distribute themselves along the desired pathway. The path for these flux lines is generally a complex function comprised of two major factors, namely, the shortest magnetic pathway for the flux lines, and the least amount of magnetic reluctance along that pathway. The magnetic flux pathway becomes more complex and devious as the soft magnetic medium approaches saturation. However, evenly distributed flux lines across the core volume still tend to be the norm. Thus, the magnetic devices described herein applies the principle of uniform flux distribution within soft magnetic materials such as silicone iron (SiFe) to several well known magnetic devices, such as magnetic bearings, motor stators and rotors, magnetic position sensors and the like.

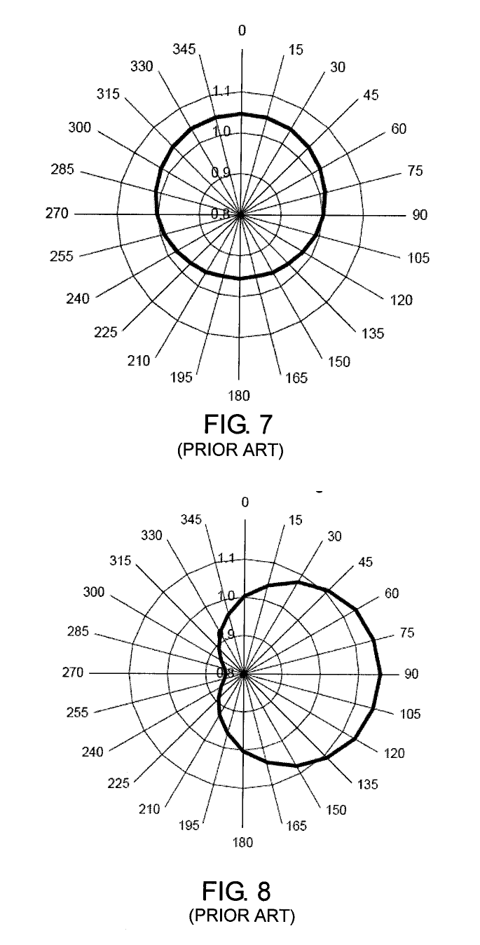

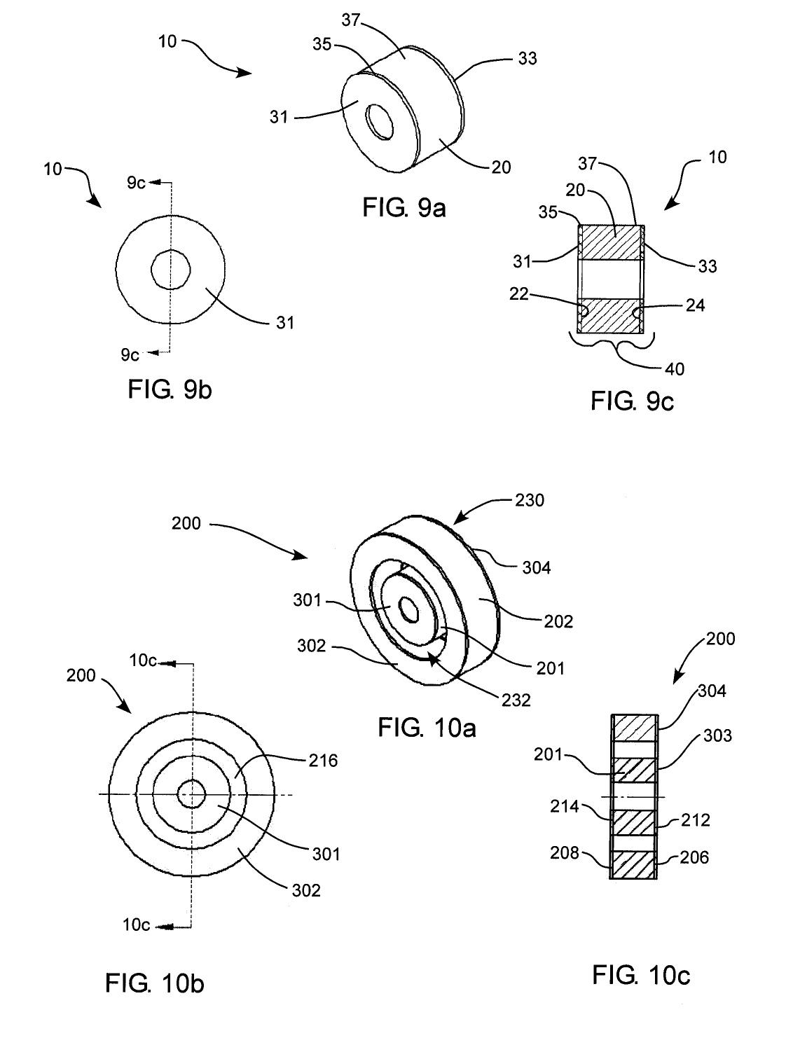

As illustrated in FIGS. 9a-9c, a permanent magnet device, indicated generally at 10 is shown in accordance with an embodiment of the present invention. The magnetic device 10 can include a polarized permanent magnet 20 having two opposite pole faces 22 and 24. In one embodiment, the magnet 20 can be annular in shape.

The magnetic device 10 can also include magnetically conductive faceplates 31 and 33 disposed on each of the opposite pole faces 22 and 24 of the permanent magnet 20. Each faceplate 31 and 33 can be sized, shaped and oriented to equally distribute the magnetic flux field lines emanating from the permanent magnet 20. Each faceplate 31 and 33 can have an annular shape, and can also have an outer perimeter 35 that can be substantially flush with the outer perimeter 37 of the permanent magnet 20. Additionally, the faceplates 31 and 33 can be configured to increase the density and concentration of the magnetic flux field of the permanent magnet 20. In this way, the magnetically conductive faceplates 31 and 33 together can form a magnetic lens to concentrate and uniformly distribute the magnetic flux field of the permanent magnet 20.

Thus, as shown in FIGS. 9a and 9c, the magnetic device can be an axially polarized permanent magnet 20 onto which two magnetically conductive faceplates 31 and 33 are attached to opposite axial faces 22 and 24. In one aspect, the magnetically conductive faceplates 31 and 33 can be thin washers or washer-shaped discs that can be attached to the axial faces of 22 and 24 of the permanent magnet 20. The faceplates 31 and 33 can be formed from a soft magnetic conductive material, such as silicone iron (SiFe) that provides a low reluctance pathway for the magnetic flux field lines emanating from the axial faces 22 and 24 of the magnet 20.

Advantageously, the application of the washers or faceplates 31 and 33 can provide for two magnetically complimentary functions for the magnetic field generated internally by the axially polarized magnet 20. First, the faceplates 31 and 33 can provide a means to equally distribute the magnetic field flux lines emanating from the magnet 20. For example, in numerous empirical measurements of various magnets and magnet arrays, as well as in computer magnetic models of these same configurations, it has been shown that applications of silicone iron devices such as the faceplates 31 and 33 have dramatically reduced the variation of field strength as a function of angular rotation within these magnets and magnet arrays by an order of magnitude or greater.

Secondly, the faceplates 31 and 33 can act as a magnetic “concentrator” or magnetic lens, indicated generally at 40, for these flux lines. Advantageously, an apparent increase in the magnetic flux density emanating from a magnet 20 with a magnetic lens 40 as described in the embodiments of the present invention shown herein, has also been observed in numerous empirical measurements and computer model simulations. Thus, the washers or faceplates 31 and 33 can act as magnetic lenses 40 to both concentrate and uniformly distribute the magnetic field flux of a permanent magnet.

It will be appreciated that while the permanent magnet 20 or magnet assembly 10 can be axially polarized, as described above and shown in FIGS. 9a-9c, other magnetic orientations are also possible under the concepts of the present invention. For example, in another aspect, the permanent magnet or magnet assembly can be radially polarized (not shown).

It will also be appreciated that while the permanent magnet 20 or magnet assembly 10 can have an annular shape, as shown in the figures, magnets having other shapes can also benefit from the concepts of the present invention. Thus, the permanent magnet and faceplates can have a disk or cylinder shape, a bar shape, a horseshoe shape, and the like.

Turning to FIGS. 10a-10c, a permanent magnet bearing device, indicated generally at 200 is shown in accordance with another embodiment of the present invention. The magnetic bearing device 200 can include a stator magnet assembly, indicated generally at 230, and a rotor magnet assembly, indicated generally at 232.

The stator magnet assembly 230 can include an axially polarized permanent magnet 202 with a pair of opposite axial faces 206 and 208. A faceplate 302 and 304 can be coupled to each of the opposite axial faces 206 and 208, respectively. In one aspect, the stator magnet 202 can be relatively larger than the rotor magnet assembly 212 and can have an annular shape.

The rotor magnet assembly 232 can also have an axially polarized permanent magnet 201 with a pair of opposite axial faces 212 and 214. A faceplate 301 and 303 can be coupled to each of the opposite axial faces 212 and 214, respectively. Additionally, the rotor magnet 201 can also have an annular shape, and can be relatively smaller than the stator magnet 202. In one aspect, the rotor magnet 201 can be sized and shaped to fit within the annulus opening 216 of the stator magnet. In this way, the rotor magnet and the stator magnet assemblies can be concentric to one another, as illustrated In FIGS. 10a and 10b.

Each of the plurality of magnetically conductive faceplates 301, 302, 303 and 304 can be disposed on a respective axial face 206, 208, 212, and 214 of the rotor and stator magnets 201 and 202. In one aspect, the magnetically conductive faceplates 301, 302, 303, and 304 can be magnetically soft washers including a soft magnetic material such as silicone iron (SiFe), silicon-iron alloys, amorphous crystalline alloys, nano-crystalline alloys, nickel-iron alloys, soft ferrites, nickel-cobalt alloys, and combinations of these materials.

The magnetically conductive faceplates 301, 302, 303 and 304 can be in direct contact with the rotor magnet 201 and the stator magnet 202. Additionally, each faceplate 301, 302, 303 and 304 can be shaped and oriented with respect to one another to uniformly distribute and concentrate a magnetic flux field emanating from the rotor and stator magnets 201 and 202. In this way, the application of the magnetically conductive faceplates 301, 302, 303 and 304 of the rotor and stator magnets 201 and 202 acts to both uniformly distribute, and to concentrate the magnetic flux field emanating from the rotor magnet 201 and the stator magnet 202.

Additionally, as illustrated in FIGS. 10a-10c, with the rotor and stator magnets are concentric to one another; the faceplates 301, 302, 303, and 304 can also be concentric to one another. Specifically, faceplates 301 and 303 that fit on the axial faces of the rotor magnet 201 can be concentric with the faceplates 302 and 304 that fit on the axial faces of the stator magnet 202.

Additionally, it will be appreciated that while the permanent magnets or magnet assemblies described above and shown in FIGS. 10a-10c can be axially polarized, other magnetic orientations are also possible under the concepts of the present invention. For example, in one aspect, the stator magnet or magnet assembly can be axially polarized and the rotor magnet or magnet assembly can be axially polarized, as shown in FIGS. 10a-10c. In another aspect, the stator magnet or magnet assembly can be radially polarized and the rotor magnet or magnet assembly can be radially polarized. In yet another aspect, the stator magnet or magnet assembly can be axially polarized and the rotor magnet or magnet assembly is radially polarized. In yet another aspect, the stator magnet or magnet assembly can be radially polarized and the rotor magnet or magnet assembly is axially polarized.

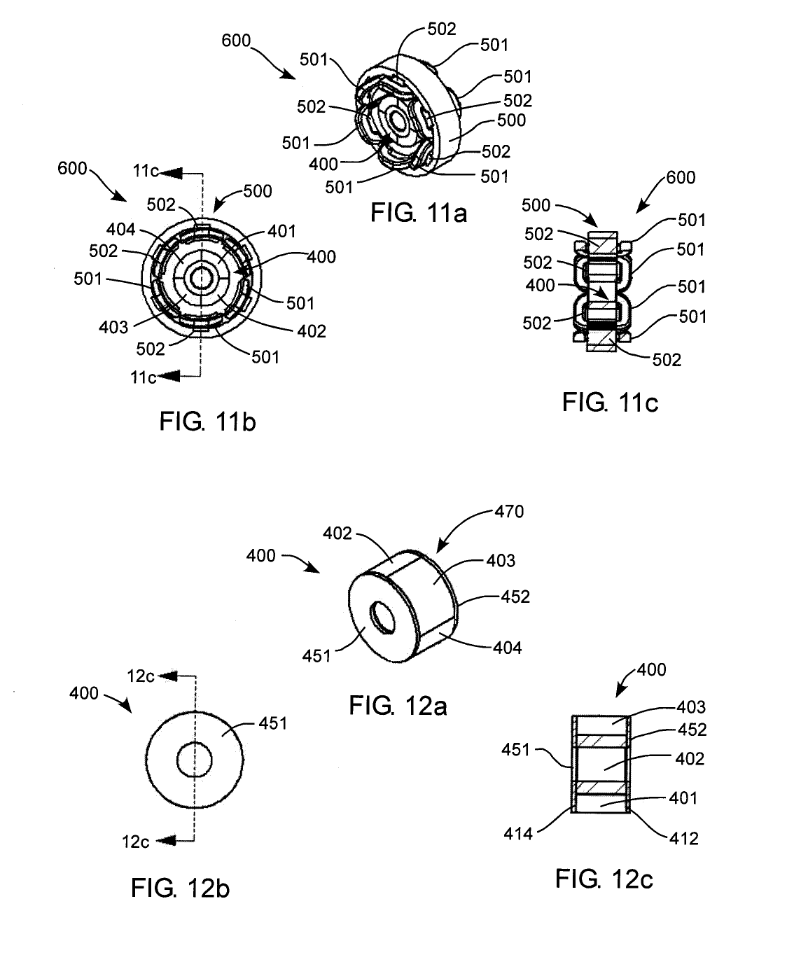

Turning now to FIGS. 11a-12c, an electromagnetic motor device, indicated generally at 600, is shown in accordance with another embodiment of the present invention. The motor device 600 can include a motor stator, indicated generally at 500, having an annulus shape and a plurality of magnetic poles 502 disposed around the annulus, and a number of motor coils 501 that can encompass the motor stator magnetic poles 502.

The motor device 600 can also have a rotor, indicated generally at 400, disposed within the annulus of the motor stator 500. The rotor 400 can also include an axially polarized permanent magnet, indicated generally at 470, having a pair of opposite axial faces 412 and 414. In one aspect, the permanent magnet rotor 400 can include a plurality of adjoining magnet arc segments 401, 402, 403 and 404 that form an annulus, and together form the permanent magnet 470 of the rotor 400. Each of the magnetic segments 401, 402, 403 and 404 can have alternately swapped axial pole orientations.

Additionally, the rotor 400 can include a plurality of magnetically conductive faceplates 451 and 452 with each faceplate disposed on a respective axial face 412 and 414 of the permanent magnet 470 to form a permanent magnet assembly. Each faceplate 451 and 452 can be sized, shaped, and oriented with respect to one another so as to uniformly distribute, increase the density of, and concentrate the magnetic flux field emanating from the rotor magnet arc segments 401, 402, 403 and 404.

For example, as shown in FIG. 11, a typical six pole motor stator 500 is shown having six motor coils 501. Within this typical motor assembly, the rotor 400 is disposed inside the stator assembly 500, and includes four rotor magnet segments 401, 402, 403 and 404 whose magnetic axial pole orientations are alternately swapped, that is 401 equals N to S, 402 equals S to N, 403 equals N to S, and 404 equals S to N. Additionally, as shown in FIGS. 12a and 12c the rotor assembly 400 includes the rotor washers 451 and 452 which are applied to the magnet segments 401, 402, 403 and 404 to uniformly distribute and concentrate the flux emanating from the four separate rotor magnet segments 401, 402, 403 and 404.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A permanent magnet device, comprising:
a polarized permanent magnet having two opposite end pole faces transverse to an axis of the magnet; and
a pair of magnetically conductive faceplates with each faceplate disposed on a different opposite pole face of the permanent magnet to form a permanent magnet assembly with the permanent magnet, and each faceplate being sized, shaped and oriented to equally and uniformly distribute magnetic flux field lines emanating from the permanent magnet, and to increase and concentrate the magnetic field flux density emanating from the permanent magnet or permanent magnet assembly.

2. A device in accordance with claim 1, wherein the magnetically conductive faceplates together form a magnetic lens to concentrate and uniformly distribute the magnetic flux field of the permanent magnet or permanent magnet assembly.

3. A device in accordance with claim 1, wherein the polarized permanent magnet has an annular shape and each of the pair of magnetically conductive faceplates has an annular shape corresponding to the annular shape of the magnet.

4. A device in accordance with claim 1, wherein the magnetically conductive faceplates include a soft magnetic material selected from the group consisting of silicone iron (SiFe), silicon-iron alloys, amorphous crystalline alloys, nano-crystalline alloys, nickel-iron alloys, soft ferrites, nickel-cobalt alloys, and combinations thereof.

5. A device in accordance with claim 1, further comprising a sensor associated with to the permanent magnet and operable to measure a strength of the magnetic flux field to determine a position of the permanent magnetic assembly.

6. A permanent magnet device, comprising:
a polarized permanent magnet or magnet assembly having oppositely positively and negatively charged pole faces; and
a magnetic lens, associated with the positively and negatively charged pole faces of the permanent magnet or magnet assembly, and operable to concentrate and increase the density of the magnetic flux field emanating from the permanent magnet or magnet assembly.

7. A device in accordance with claim 6, wherein the magnetic lens further includes:
a magnetically conductive faceplate disposed on the positive magnetic pole face;
a magnetically conductive faceplate disposed on the negative magnetic pole; and
the magnetically conductive faceplates are shaped and oriented with respect to one another to concentrate and increase the density of the magnetic flux field emanating from the permanent magnet or magnet assembly.

8. A device in accordance with claim 7, wherein the magnetically conductive faceplates include a soft magnetic material selected from the group consisting of silicone iron (SiFe), silicon-iron alloys, amorphous crystalline alloys, nano-crystalline alloys, nickel-iron alloys, soft ferrites, nickel-cobalt alloys, and combinations thereof.

9. A device in accordance with claim 6, wherein the permanent magnet or magnet assembly is axially polarized.

10. A device in accordance with claim 6, wherein the permanent magnet or magnet assembly is radially polarized.

11. A permanent magnet bearing device, comprising:
a) a stator magnet or magnet assembly including a polarized permanent magnet having a pair of oppositely charged pole faces;
b) a rotor magnet or magnet assembly disposed within the stator magnet, and including a polarized permanent magnet having a pair of oppositely charged pole faces; and
c) a plurality of magnetically conductive faceplates with each faceplate disposed on a different pole face of the rotor and stator magnets or magnet assemblies, and each faceplate being shaped and oriented with respect to the other faceplates to uniformly distribute and concentrate magnetic flux fields emanating from the rotor and stator magnets or assemblies.

12. A device in accordance with claim 11, wherein the plurality of magnetically conductive faceplates include a soft magnetic material selected from the group consisting of silicone iron (SiFe), silicon-iron alloys, amorphous crystalline alloys, nano-crystalline alloys, nickel-iron alloys, soft ferrites, nickel-cobalt alloys, and combinations thereof.

13. A device in accordance with claim 11, wherein the stator magnet or magnet assembly is axially polarized and the rotor magnet or magnet assembly is axially polarized.

14. A device in accordance with claim 11, wherein the stator magnet or magnet assembly is radially polarized and the rotor magnet or magnet assembly is radially polarized.

15. A device in accordance with claim 11, wherein the stator magnet or magnet assembly is axially polarized and the rotor magnet or magnet assembly is radially polarized.

16. A device in accordance with claim 11, wherein the stator magnet or magnet assembly is radially polarized and the rotor magnet or magnet assembly is axially polarized.

17. A device in accordance with claim 11, wherein the stator magnet or magnet assembly has an annular shape and the rotor magnet or magnet assembly is disposed inside an opening of the annulus.

18. An electromagnetic motor device, comprising:
a) a motor stator having an annulus shape and a plurality of magnetic poles disposed around the annulus; and
b) a motor rotor disposed within the annulus of the motor stator, the motor rotor further comprising:
i) a polarized permanent magnet or magnet assembly having a pair of opposite pole faces; and
ii) a plurality of magnetically conductive faceplates having an annulus shape corresponding in size with the annulus of the motor stator, each faceplate disposed on a different pole face of the permanent magnet, and each faceplate being shaped and oriented with respect to the other faceplates to uniformly distribute and concentrate magnetic flux fields emanating from the rotor and stator magnets.

19. A device in accordance with claim 18, the permanent magnet of the motor rotor further comprising:
a plurality of adjoining magnet arc segments forming an annulus with each having alternately swapped axial pole orientations.

20. A device in accordance with claim 18, wherein the plurality of magnetically conductive faceplates include a soft magnetic material selected from the group consisting of silicone iron (SiFe), silicon-iron alloys, amorphous crystalline alloys, nano-crystalline alloys, nickel-iron alloys, soft ferrites, nickel-cobalt alloys, and combinations thereof.
